(19) United States
(12) Patent Application Publication
(10) Pub. No.: US 2006/0029397 A1
(43) Pub. Date: Feb. 9, 2006

(54) Method and apparatus for transmitting a signal using simultaneous FM and AM modulation

(76) Inventors: Daniel Mahgerefteh, Los Angeles, CA (US); Yasuhiro Matsui, Lawrence, MA (US); Parviz Tayebati, Weston, MA (US); Xueyan Zheng, Culver City, CA (US)

Correspondence Address: Mark J. Pandiscio;Pandiscio & Pandiscio, P.C., 470 Totten Pond Road, Waltham, MA, 02451-1914, US

(21) Appl. No.: 11/084,633

(22) Filed: Mar. 18, 2005

Related U.S. Application Data
(63) Continuation-in-part of application No. 10/289,944, filed on Nov. 6, 2002, now Pat. No. 6,963,685.
(63) Continuation-in-part of application No. 10/308,522, filed on Dec. 3, 2002.
(63) Continuation-in-part of application No. 10/680,607, filed on Oct. 6, 2003.
(63) Continuation-in-part of application No. 11/068,032, filed on Feb. 28, 2005.
(60) Provisional application No. 60/554,249, filed on Mar. 18, 2004.
(60) Provisional application No. 60/554,243, filed on Mar. 18, 2004.
(60) Provisional application No. 60/569,769, filed on May 10, 2004.
(60) Provisional application No. 60/569,768, filed on May 10, 2004.
(60) Provisional application No. 60/581,076, filed on Jun. 18, 2004.
(60) Provisional application No. 60/615,834, filed on Oct. 4, 2004.

(51) Int. Cl. H04B 10/04

(52) U.S. Cl. 398/187

(57) ABSTRACT

There is provided method for transmitting binary data contained in respective successive time cells, the data being in the form of an optical signal obtained by amplitude modulation and frequency modulation of an optical carrier wave, with a 0 bit data value having a 0 bit mean amplitude having a 0 bit amplitude time duration and a 0 bit frequency having a 0 bit frequency duration, and a 1 bit data value having a 1 bit mean amplitude having a 1 bit amplitude time duration and a 1 bit frequency having a 1 bit frequency duration; the improvement wherein: independently adjusting the 0 bit mean amplitude relative to the 1 bit mean amplitude; independently adjusting the 0 bit frequency relative to the 1 bit frequency; and independently adjusting time duration of the frequency profile of the 1 bit relative to the time duration of the amplitude profile of the 1 bit, whereby to extend the error-free propagation of the optical signal though a dispersive optical fiber beyond the dispersion limit. There is provided a method for transmitting Non-Return-To-Zero (NRZ) binary data contained in respective successive time cells, the data being in the form of an optical signal obtained by amplitude modulation and frequency modulation of an optical carrier wave, with a 0 bit data value having a 0 bit mean amplitude having a 0 bit amplitude time duration and a 0 bit frequency having a 0 bit frequency duration, and a 1 bit data value having a 1 bit mean amplitude having a 1 bit amplitude time duration and a 1 bit frequency having a 1 bit frequency duration; the improvement wherein: the phase across each 1 bit data value is substantially constant, and the phase of the carrier changes across each and every 0 bit by an amount equal to the product of the frequency difference between the 1 bit and the 0 bit and the duration of the 0 bit; whereby to extend the error-free propagation of the optical signal though a dispersive optical fiber beyond the dispersion limit. In accordance with one form of the present invention, there is provided a method for transmitting binary data contained in respective successive time cells, the data being in the form of an optical signal obtained by amplitude modulation and frequency modulation of an optical carrier wave, with a 0 bit data value having a 0 bit mean amplitude having a 0 bit amplitude time duration and a 0 bit frequency having a 0 bit frequency duration, and a 1 bit data value having a 1 bit mean amplitude having a 1 bit amplitude time duration and a 1 bit frequency having a 1 bit frequency duration; the improvement wherein: the amplitude profile of the 1 bit is substantially bell-shaped, and the frequency profile of the 1 bit is substantially square-shaped, with steeper rise and fall time and a wider flat top region; whereby to extend the error-free propagation of the optical signal though a dispersive optical fiber beyond the dispersion limit.

### REFERENCE TO PENDING PRIOR PATENT APPLICATIONS

This patent application:

(i) claims benefit of pending prior U.S. Provisional Patent Application Ser. No. 60/554,249, filed Mar. 18, 1004 by Daniel Mahgerefteh et al. for METHOD AND TRANSMISSION USING PARTIAL FM AND AM MODULATION (Attorney Docket No. TAYE-33 PROV);

(ii) claims benefit of pending prior U.S. Provisional Patent Application Ser. No. 60/554,243, filed Mar. 18, 2004 by Daniel Mahgerefteh et al. for FLAT CHIRP INDUCED BY FILTER EDGE (Attorney Docket No. TAYE-34 PROV);

(iii) claims benefit of pending prior U.S. Provisional Patent Application Ser. No. 60/569,769, filed May 10, 2004 by Daniel Mahgerefteh et al. for FLAT CHIRP INDUCED BY AN OPTICAL FILTER EDGE (Attorney Docket No. TAYE-40 PROV);

(iv) claims benefit of pending prior U.S. Provisional Patent Application Ser. No. 60/569,768, filed May 10, 2004 by Daniel Mahgerefteh et al. for METHOD OF TRANSMISSION USING PARTIAL FM AND AM MODULATION (Attorney's Docket No. TAYE-41 PROV);

(v) claims benefit of pending prior U.S. Provisional Patent Application Ser. No. 60/581,076, filed Jun. 18, 2004 by Daniel Mahgerefteh et al. for PHASE CORRELATED AMPLITUDE MODULATION (Attorney's Docket No. TAYE-42 PROV);

(vi) claims benefit of pending prior U.S. Provisional Patent Application Ser. No. 60/615,834, filed Oct. 04, 2004 by Daniel Mahgerefteh et al. for PHASE CORRELATED QUADRATURE AMPLITUDE MODULATION (Attorney's Docket No. TAYE-45 PROV);

(vii) is a continuation-in-part of pending prior U.S. patent application Ser. No. 10/289,944, filed Nov. 6, 2002 by Daniel Mahgerefteh et al. for POWER SOURCE FOR A DISPERSION COMPENSATION FIBER OPTIC SYSTEM (Attorney Docket No. TAYE-59474-00006);

(viii) is a continuation-in-part of pending prior U.S. patent application Ser. No. 10/308,522, filed Dec. 3, 2002 by Daniel Mahgerefteh et al. for HIGH-SPEED TRANSMISSION SYSTEM COMPRISING A COUPLED MULTI-CAVITY OPTICAL DISCRIMINATOR (Attorney Docket No. TAYE-59474-00007);

(ix) is a continuation-in-part of pending prior U.S. patent application Ser. No. 10/680,607, filed Oct. 06, 2003 by Daniel Mahgerefteh et al. for FLAT DISPERSION FREQUENCY DISCRIMINATOR (FDFD) (Attorney Docket No. TAYE-59474-00009); and

(x) is a continuation-in-part of pending prior U.S. patent application Ser. No. 11/068,032, filed Feb. 28, 2005 by Daniel Mahgerefteh et al. for OPTICAL SYSTEM COMPRISING AN FM SOURCE AND A SPECTRAL RESHAPING ELEMENT (Attorney Docket No. TAYE-31).

The ten above-identified patent applications are hereby incorporated herein by reference.

### FIELD OF THE INVENTION

This invention relates to signal transmissions in general, and more particularly to the transmission of optical signals and electrical signals.

### BACKGROUND OF THE INVENTION

The quality and performance of a digital transmitter is determined by the distance over which the transmitted digital signal can propagate without severe distortions. This is typically characterized as the distance over which a dispersion penalty reaches a level of ˜1 dB. A standard 10 Gb/s optical digital transmitter, such as an externally modulated source, can transmit up to a distance of ˜50 km in standard single mode fiber at 1550 nm before the dispersion penalty reaches the level of ˜1 dB. This distance is typically called the dispersion limit. The dispersion limit is determined by the fundamental assumption that the digital signal is transform-limited, i.e., the signal has no time-varying phase across its bits and the signal has a bit period of 100 ps, or 1/(bit rate) for a 10 Gb/s optical digital transmitter.

It has been recognized that adding phase modulation to an amplitude modulated optical signal can increase the signal's tolerance to dispersion. One such method, which is sometimes called “optical duobinary transmission” or, alternatively, “phase reshaped binary transmission”, is disclosed in U.S. Pat. No. 5,920,416. In this method, the phase of the optical signal is changed by a discrete step during the zero bits that precede or succeed each block of 1 bits (or each isolated 1 bit) by an appropriate amount. The method disclosed in U.S. Pat. No. 5,920,416 has been found to be quite useful. However, this method is also complex and requires special coding. Additionally, in cases where the digital signal must propagate beyond 200 km, the dispersion penalty for this duobinary technique rapidly increases with increasing distance.

As a result, one object of the present invention is to provide a new and improved transmission system which increases the dispersion tolerance to a greater extent than the prior art, and which utilizes a simpler implementation which does not require any special coding.

### SUMMARY OF THE INVENTION

The present invention provides a new method and apparatus which increases the dispersion tolerance to a greater extent than the prior art, and which utilizes a simpler implementation which does not require any special coding. In the present invention, this is achieved by simultaneous frequency and amplitude modulation of the binary signal, where the frequency excursion has a certain relationship to the bit period.

In one preferred form of the invention, the frequency and amplitude modulated signal is configured so that (i) each of the 1 bit pulses has a uniform phase (i.e., a flat-topped frequency profile), and (ii) during all 0 bits, the phase of the signal is changed in a continuous fashion relative to the phase of the immediately-preceding 1 bit.

In another form of the invention, the signal is configured using simultaneous frequency and amplitude modulation, such that the frequency excursion multiplied by the time duration of the zero bits in the time profile is equal to an integer multiple of ½, or, stated another way, where the frequency excursion of a 1 bit is Δf, and where the time duration of the 0 bits in the frequency profile is ti₀, Δf×ti₀=β×(½) where β is an integer.

Various systems may be used to generate this frequency modulated/amplitude modulated (FM/AM) signal. By way of example but not limitation, various systems for the simultaneous frequency and amplitude modulation of a binary signal have been disclosed as follows:

(1) the use of an optical source that can generate an adiabatically-chirped signal with amplitude modulation, and the use of an optical spectrum reshaper to shape the frequency modulation to the appropriate functional form as well as to increase the amplitude modulation, as disclosed in (i) pending prior U.S. patent application Ser. No. 10/289,944, filed Nov. 6, 2002 by Daniel Mahgerefteh et al. for POWER SOURCE FOR A DISPERSION COMPENSATION FIBER OPTIC SYSTEM (Attorney's Docket No. TAYE-59474-00006), (ii) pending prior U.S. Provisional Patent Application Ser. No. 60/569,76.9, filed May 10, 2004 by Daniel Mahgerefteh et al. for FLAT CHIRP INDUCED BY AN OPTICAL FILTER EDGE (Attorney Docket No. TAYE-40 PROV); and (iii) pending prior U.S. Provisional Patent Application Ser. No. 60/554,243, filed Mar. 18, 2004 by Daniel Mahgerefteh et al. for FLAT CHIRP INDUCED BY FILTER EDGE (Attorney Docket No. TAYE-34 PROV), which three patent applications are hereby incorporated herein by reference; and

(2) the use of independently driven amplitude and frequency modulators, e.g., where drivers allow the rise time, the fall time and the duration of the bits to be different for the frequency modulation and the amplitude modulation, as disclosed in pending prior U.S. patent application Ser. No. 11/068,032, filed Feb. 28, 2005 by Daniel Mahgerefteh et al. for OPTICAL SYSTEM COMPRISING AN FM SOURCE AND A SPECTRAL RESHAPING ELEMENT (Attorney Docket No. TAYE-31), which patent application is hereby incorporated herein by reference.

In one form of the present invention, there is provided method for transmitting binary data contained in respective successive time cells, the data being in the form of an optical signal obtained by amplitude modulation and frequency modulation of an optical carrier wave, with a 0 bit data value having a 0 bit mean amplitude having a 0 bit amplitude time duration and a 0 bit frequency having a 0 bit frequency duration, and a 1 bit data value having a 1 bit mean amplitude having a 1 bit amplitude time duration and a 1 bit frequency having a 1 bit frequency duration;

the improvement wherein:

independently adjusting the 0 bit mean amplitude relative to the 1 bit mean amplitude;

independently adjusting the 0 bit frequency relative to the 1 bit frequency; and

independently adjusting time duration of the frequency profile of the 1 bit relative to the time duration of the amplitude profile of the 1 bit,

whereby to extend the error-free propagation of the optical signal though a dispersive optical fiber beyond the dispersion limit.

In another form of the present invention, there is provided a method for transmitting binary data contained in respective successive time cells, the data being in the form of an electrical signal obtained by amplitude modulation and frequency modulation of an electrical carrier wave, with a 0 bit data value having a 0 bit mean amplitude having a 0 bit amplitude time duration and a 0 bit frequency having a 0 bit frequency duration, and a 1 bit data value having a 1 bit mean amplitude having a 1 bit amplitude time duration and a 1 bit frequency having a 1 bit frequency duration;

the improvement wherein:

independently adjusting the 0 bit mean amplitude relative to 1 bit mean amplitude;

independently adjusting the 0 bit frequency relative to the 1 bit frequency; and

independently adjusting the frequency time duration of the 1 bit relative to the amplitude time duration of the 1 bit,

whereby to extend the error-free propagation of the electrical signal though a dispersive waveguide beyond the dispersion limit.

In another form of the present invention, there is provided a method for transmitting Non-Return-To-Zero (NRZ) binary data contained in respective successive time cells, the data being in the form of an optical signal obtained by amplitude modulation and frequency modulation of an optical carrier wave, with a 0 bit data value having a 0 bit mean amplitude having a 0 bit amplitude time duration and a 0 bit frequency having a 0 bit frequency duration, and a 1 bit data value having a 1 bit mean amplitude having a 1 bit amplitude time duration and a 1 bit frequency having a 1 bit frequency duration;

the improvement wherein:

the phase across each 1 bit data value is substantially constant, and the phase of the carrier changes across each and every 0 bit by an amount equal to the product of the frequency difference between the 1 bit and the 0 bit and the duration of the 0 bit;

whereby to extend the error-free propagation of the optical signal though a dispersive optical fiber beyond the dispersion limit.

In another form of the present invention, there is provided a method for transmitting binary data contained in respective successive time cells, the data being in the form of an optical signal obtained by amplitude modulation and frequency modulation of an optical carrier wave, with a 0 bit data value having a 0 bit mean amplitude having a 0 bit amplitude time duration and a 0 bit frequency having a 0 bit frequency duration, and a 1 bit data value having a 1 bit mean amplitude having a 1 bit amplitude time duration and a 1 bit frequency having a 1 bit frequency duration;

the improvement wherein:

the amplitude profile of the 1 bit is substantially bell-shaped, and the frequency profile of the 1 bit is substantially square-shaped, with steeper rise and fall time and a wider flat top region;

whereby to extend the error-free propagation of the optical signal though a dispersive optical fiber beyond the dispersion limit.

### BRIEF DESCRIPTION OF THE DRAWINGS

These and other objects and features of the present invention will be more fully disclosed or rendered obvious by the following detailed description of the preferred embodiments of the invention, which is to be considered together with the accompanying drawings wherein like numbers refer to like parts and further wherein:

FIG. 1 is a schematic diagram illustrating adiabatically chirped amplitude modulation of a signal, with amplitude modulation and frequency modulation being shown plotted along the same time axis;

FIG. 2 is a schematic illustration showing the instantaneous intensity, frequency and phase of a binary bit sequence having an instantaneous frequency value of 5 GHz, both before and after passage through an Optical Spectrum Reshaper (OSR);

FIG. 3 is a schematic illustration of the instantaneous amplitude and frequency profiles of a data pulse, with the illustration being labeled with various definitions associated with the amplitude and frequency profiles of the data pulse;

FIG. 4 is an illustration plotting pulse width versus fiber dispersion (on the X axis, fiber dispersion is expressed in terms of an equivalent fiber length at 17 ps/nm/km, where negative length indicates negative dispersion—three cases are shown: (a) Frequency Reshaped Binary Transmission (FRBT) for extinction ratio values of 10 and 13 dB, (b) unchirped square-shaped Non-Return-To-Zero (NRZ) pulses, and (c) Gaussian pulses;

FIG. 5 is an illustration of an eye diagram for a single 1 bit showing that the peak on the rising edge does not close the eye, while the destructive interference helps to sharpen the pulse;

FIG. 6 is an illustration showing the eye opening in the presence of dispersion by destructive interference; and

FIG. 7 shows the amplitude and frequency profiles and phase variation for a random NRZ bit sequence generated according to a preferred embodiment of the present invention.

### DETAILED DESCRIPTION OF THE PREFERRED EMBODIMENTS

### Phase Coding by Direct Modulation

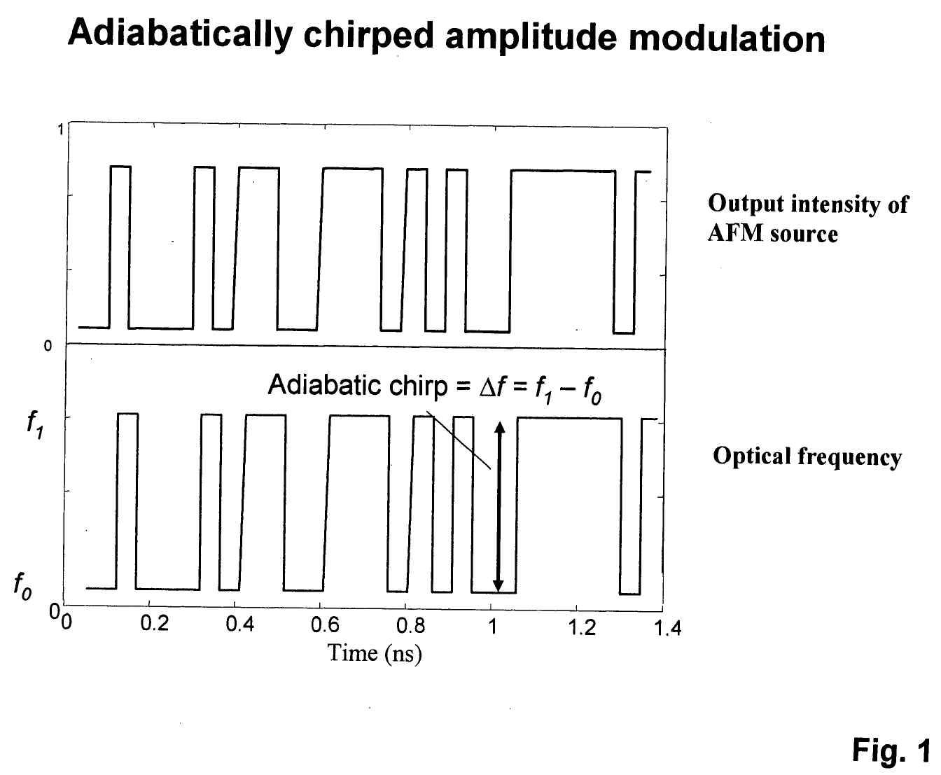

In one preferred embodiment of the present invention, a frequency modulated source, such as a directly modulated Distributed Feedback (DFB) laser, is modulated with a digital signal. The laser is biased high above threshold, for example at 80 mA, and modulated with a small current modulation to provide a signal with a small Extinction Ratio (ER) of ˜1-3 dB. Because of the linewidth enhancement effect and gain compression in the laser, the optical frequency of the laser has approximately the same temporal profile as the intensity modulation, as shown in FIG. 1. This property of directly modulated lasers has been known to those skilled in the art.

The instantaneous frequency of the laser changes between two extremes (f₁ and f₀), and this difference (Δf) is sometimes referred to herein as adiabatic chirp. The Extinction Ratio (ER) of the output (defined as the ratio of the 1 bit mean amplitude to the 0 bit mean amplitude) can be varied over a wide range, depending on the FM efficiency of the laser. The FM efficiency of the laser can be defined as the ratio of the adiabatic chirp to the modulation current, and it is measured in GHz/mA. A higher modulation current increases the Extinction Ratio (ER), as well as increasing the adiabatic chirp.

In a preferred embodiment of the present invention, the adiabatic chirp is chosen to be a given value, as described below. Thus, for a given FM efficiency, the desired adiabatic chirp specifies the modulation current; and the specified modulation current in turn determines the Extinction Ratio (ER). In other words, for a laser of given FM efficiency, choosing the degree of adiabatic chirp (i.e., Δf) determines the Extinction Ratio (ER) of the signal. For example, for a 10 Gb/s Non-Return-To-Zero (NRZ) signal, generated by a Distributed Feedback (DFB) laser with an FM efficiency of ˜0.2 GHz/mA, where the desired chirp is ˜4 GHz, the ER is ˜1 dB.

An Optical Spectrum Reshaper (OSR) used after the output of the laser increases the extinction ratio to between ˜10-13 dB.

Another important function of the Optical Spectrum Reshaper (OSR) is to reshape the frequency profile of the signal so as to convert the frequency profile from the adiabatic chirp profile associated with the laser to a more desirable, square-shaped frequency profile having fast rise and fall times. Such a system has been disclosed in (i) pending prior U.S. Provisional Patent Application Ser. No. 60/554,243, filed Mar. 18, 2004 by Daniel Mahgerefteh et al. for FLAT CHIRP INDUCED BY FILTER EDGE (Attorney Docket No. TAYE-34 PROV), and (ii) pending prior U.S. Provisional Patent Application Ser. No. 60/569,769, filed May 10, 2004 by Daniel Mahgerefteh et al. for FLAT CHIRP INDUCED BY AN OPTICAL FILTER EDGE (Attorney Docket No. TAYE-40 PROV), which two patent applications are hereby incorporated herein by reference.

As the frequency of the laser changes with time (i.e., as the laser chirps), the optical phase of the carrier signal changes with time across the bits as well. One important aspect of the present invention is the recognition that this phase change can be used advantageously. The optical phase change depends on the bit period, the rise times and fall times, and the adiabatic chirp. When the laser is modulated by a digital signal with bit period T, the optical phase difference between two bits depends on the adiabatic chirp as well as the total time difference between the bits. This phase difference can be used to advantage, as is shown in the example below.

More particularly, an optical electric field E(t) is characterized by an amplitude envelope, a time varying phase, and a carrier frequency as follows:
E(t)=A(t)exp(−i₀t+iφ(t)) (1)
where A(t) is the amplitude envelope, ω₀ is the optical carrier frequency, and φ(t) is the time varying phase. For example, for a chirp free pulse or a transform limited pulse, the time varying phase is zero.

The instantaneous frequency f(t) is generally defined by:

$$f ( t ) = - \frac{1}{2 π} \frac{ⅆ ϕ ( t )}{ⅆ t} \qquad ( 2 )$$

Note that the negative sign in Equation (2) is based on the complex notation convention that takes the carrier frequency to be represented by exp(−iω₀t).

Hence, the optical phase difference Δφ between two time points on the optical field is given by:
Δφ=φ(t₂)−φ(t₁)=−2π∫ₜ_{₁}^{t}^{₂}f(t)dt (3)

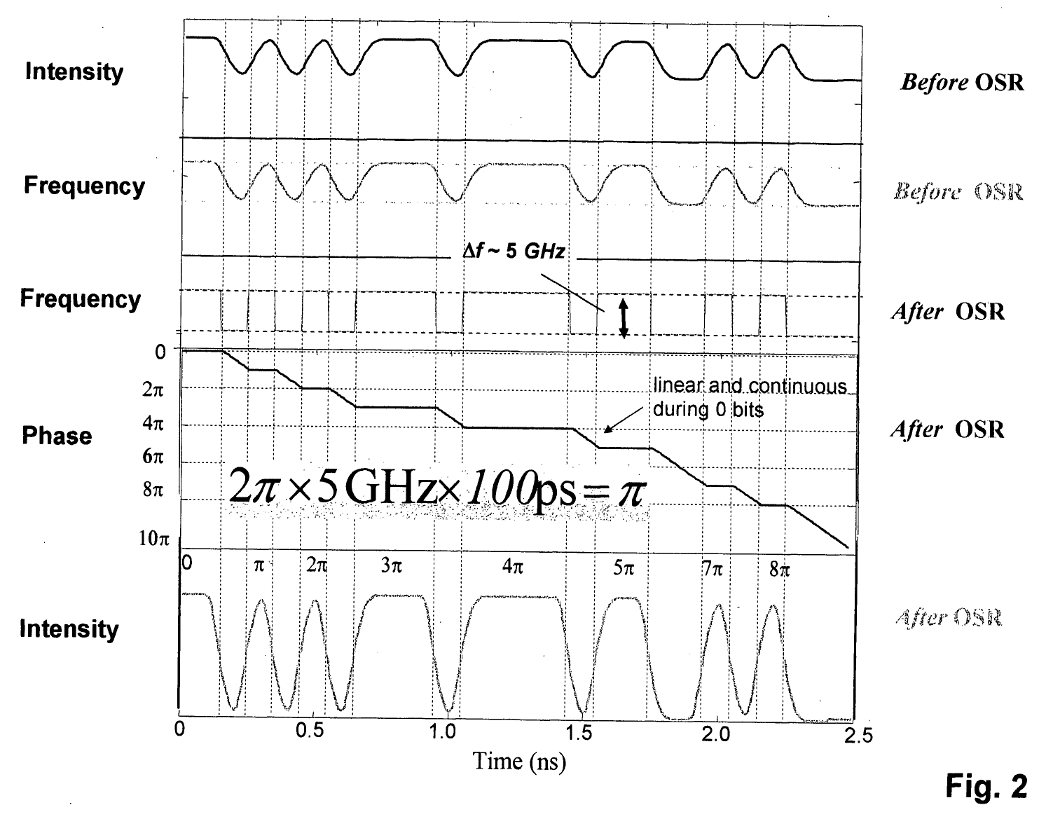

FIG. 2 illustrates how the phase and optical carrier frequency are varied in one preferred embodiment of the present invention.

Note that in prior art systems such as those disclosed in U.S. Pat. No. 5,920,416, the phase is modulated by steps in between the 0 bits. As a result, the corresponding frequency excursion is transient impulses in frequency in the middle of some of the zero bits.

By contrast, in the present invention, there is imparted a continuous frequency modulation which corresponds to the intensity modulation. The phase variation across the zero bits is generally linear and continuous.

The optical signal provided by the present invention has, among other things, two important aspects that make the signal significantly more tolerant to dispersion.

1. In a first significant aspect of the present invention, the phase across each pulse is approximately constant because of the signal's flat-topped instantaneous frequency. (Here the phase of the 1s is taken to be zero as reference without loss of generality). By choosing the frequency difference between the instantaneous frequency of the 1's and the 0's the phase between the pulses may be adjusted. In the preferred embodiment of the present invention, the frequency excursion at the output of the laser (i.e. adiabatic chirp) may be altered by the OSR, and so may have a different frequency excursion after the OSR.

For example, for a 10 Gb/s Non-Return-To-Zero (NRZ) bit sequence with 100% duty cycle (i.e., 100 ps pulses), the frequency difference (i.e., the flat-topped frequency excursion, Δf) is chosen to be 5 GHz, assuming short rise and fall times relative to the pulse duration. This results in a πphase shift for the carrier signal across a single 0 bit, as shown below:
Δφ=2π×5 GHz×100 ps=π (4)

The phase shift Δφ is 2π between two 1 bits separated by two 0 bits, and 3π for two 1 bits separated by three 0 bits, and so on.

In general, two 1 bits separated by an odd number of 0's are πout of phase for a 10 Gb/s signal having 5 GHz of chirp. For 10 Gb/s signal (square pulses) having 10 GHz of chirp, 1 bits separated by odd numbers of bits are in phase.

The Bit Error Rate (BER) of an optical digital signal after propagation though fiber, and the resulting distortion of the signal, are determined mostly by the distortions of a very few bit sequences. The 101 bit sequence, and the single bit 010 sequence, are two examples of bit sequences that have high frequency content and tend to distort most after dispersion in a fiber, leading to errors in the bit sequence. Transmission techniques that can alleviate the distortion for these bit sequences increase the dispersion tolerance of the entire Non-Return-To-Zero (NRZ) data pattern.

The significance of the phase shift discussed above becomes clear when the 101 bit sequence, with 5 GHz of flat-topped chirp, is propagated through dispersive fiber, where each pulse broadens due to its finite bandwidth. The π phase shift (recall that two 1 bits separated by an odd number of 0's are π out of phase, as noted above) causes the two 1 bits to interfere destructively at the center of the 0 bit, thereby keeping the 1 and 0 bits distinguishable from one another. Hence the decision threshold circuit in the receiver can differentiate between the 1 and 0 bits, and the pulse broadening does not increase the Bit Error Rate (BER) for this bit sequence. Therefore, the π phase shift created in accordance with the preferred embodiment of the present invention increases the signal's tolerance to dispersion.

In addition to the foregoing, it should also be appreciated that, for intermediate chirp values, there is a partial destructive interference which also acts to extend transmission distance. The interference term between the overlapping 1 bits is proportional to the cosine of their phase difference. As long as the phase different between the bits is between π/2 and 3π/2, the cosine function is negative and some destructive interference occurs. So for example, for a 10 Gb/s NRZ signal a frequency excursion between 2.5 GHz to 7.5 GHz will provide some benefit. It is therefore an embodiment of the present invention that the product of the frequency difference between the 1 bits and 0 bits with the duration of the 0 bits be between ¼ to ¾.

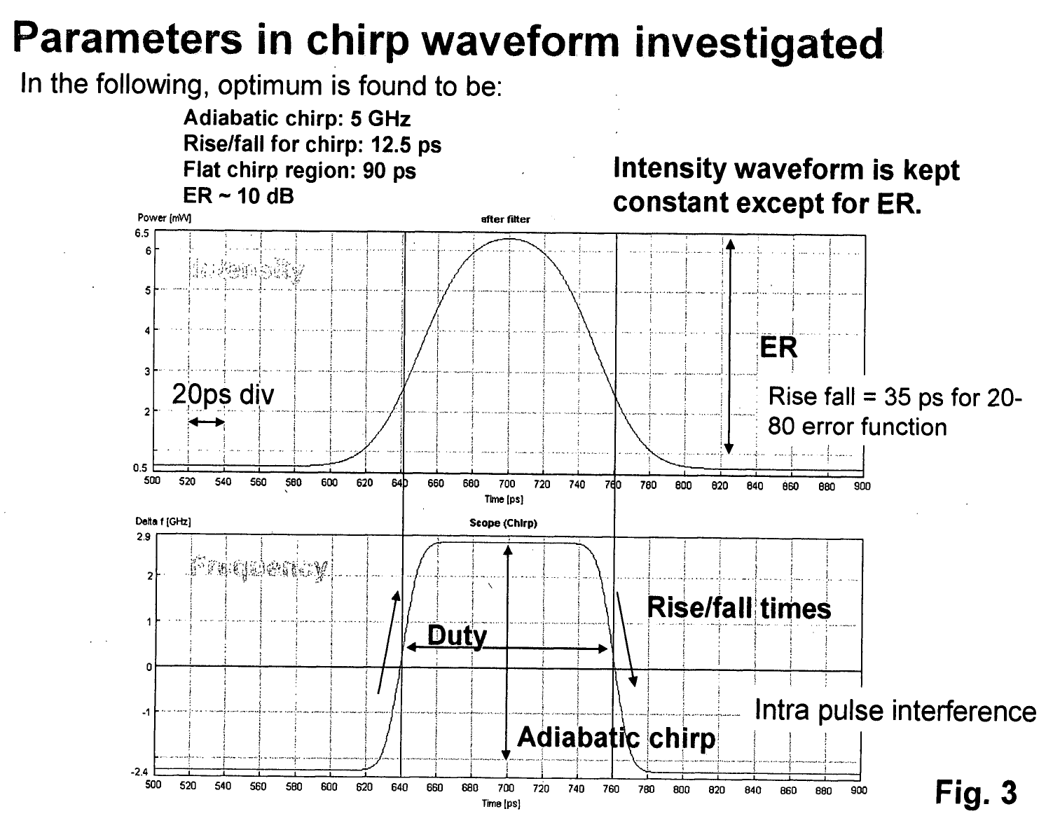

2. In a second significant aspect of the present invention, the frequency profile of the 1 bit is modified relative to the intensity profile. More specifically, whereas the intensity profile of the 1 bit is substantially bell-shaped, the frequency profile of the 1 bit is substantially squared off, with steeper rise and fall times and a longer flat top (See FIG. 3). And in one preferred arrangement, the frequency profile of the 1 bit may be configured to be substantially enscribed by the corresponding intensity profile of the 1 bit. The duration of the instantaneous frequency profile corresponding to the 1 bit is made longer than the duration of the intensity profile near the peak frequency, and the rise times and fall times of the frequency profile are made faster than that of the intensity profile. In other words, the frequency profile approaches a square, top-hat shape. This approach decreases the rate at which an isolated 1 pulse, or the 010 sequence, disperses for both positive and negative fiber dispersion.

FIG. 3 demonstrates one preferred embodiment of the present invention, wherein the relationships between the intensity and instantaneous frequency profiles are evident. In this example, the intensity profile is nearly Gaussian, while the frequency profile is chosen to be flat-topped. This configuration implies that the phase across most of the pulse is constant (same carrier frequency), whereas the wings of the pulse are made to have a different frequency. The frequency difference between the 1 bit and the 0 bit (i.e., the flat-topped frequency excursion) is adjusted so as to minimize distortion and increase the propagation of the pulse sequence beyond the normal dispersion limit.

As noted above, the amplitude and frequency modulated signal of the present invention can be generated in various ways.

By way of example, simultaneous frequency and amplitude modulation of a binary signal can be achieved through the use of an optical source that can generate an adiabatically-chirped signal with amplitude modulation, and the use of an Optical Spectrum Reshaper (OSR) to shape the frequency modulation to the appropriate functional form as well as to increase the amplitude modulation, as disclosed in (i) pending prior U.S. Provisional Patent Application Ser. No. 60/569,769, filed May 10, 2004 by Daniel Mahgerefteh et al. for FLAT CHIRP INDUCED BY AN OPTICAL FILTER EDGE (Attorney Docket No. TAYE-40 PROV); and (ii) pending prior U.S. Provisional Patent Application Ser. No. 60/554,243, filed Mar. 18, 2004 by Daniel Mahgerefteh et al. for FLAT CHIRP INDUCED BY FILTER EDGE (Attorney Docket No. TAYE-34 PROV), which two patent applications are hereby incorporated herein by reference.

Alternatively, the amplitude and frequency modulated signal can also be generated by cascading a frequency modulation source and an amplitude modulator. Each device (i.e., the frequency modulation source and the amplitude modulator) is driven independently so as to allow the rise and fall times, and the durations of the bits, to be optimized. The details of this particular construction are described in pending prior U.S. patent application Ser. No. 11/068,032, filed Feb. 28, 2005 by Daniel Mahgerefteh et al. for OPTICAL SYSTEM COMPRISING AN FM SOURCE AND A SPECTRAL RESHAPING ELEMENT (Attorney Docket No. TAYE-31), which patent application is hereby incorporated herein by reference.

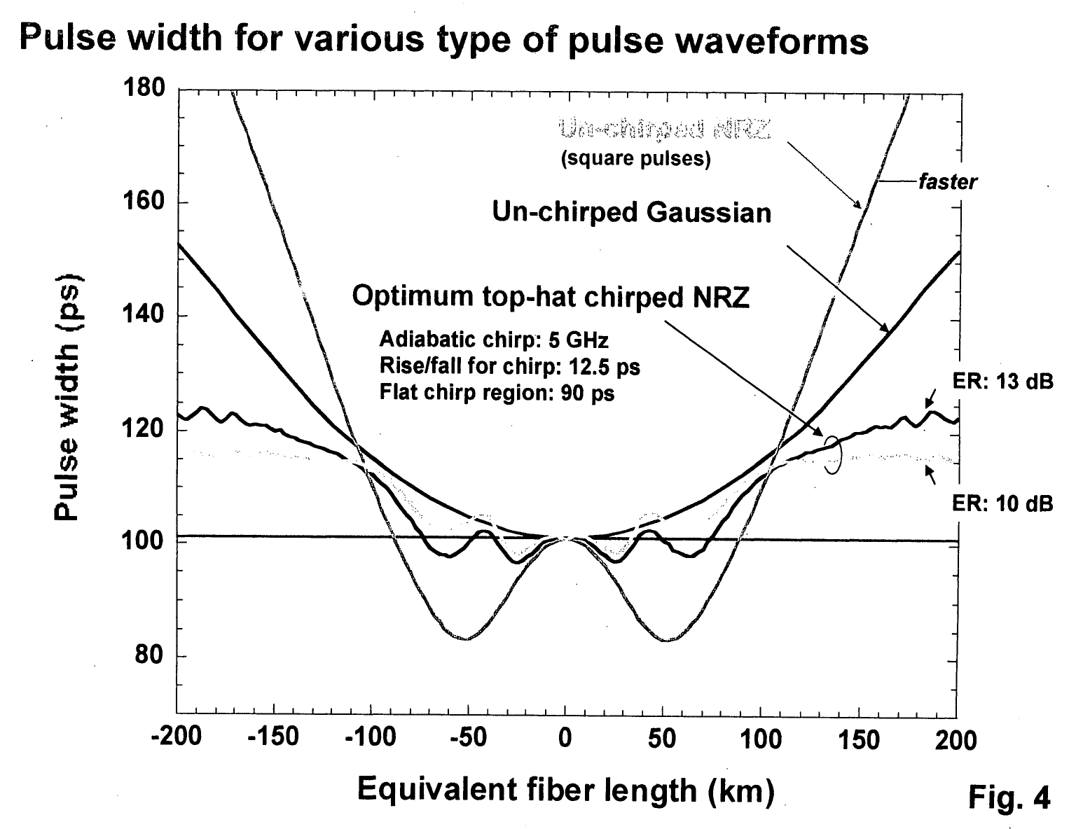

FIG. 3 shows a fast rise time and fall time for the frequency profile, and a finite extinction ratio of 10 dB for the amplitude modulation, in a preferred arrangement. Additionally, it should be noted that in FIG. 3, the wings of the pulse are one frequency, and the center of the pulse is of different frequency. In this case, the frequency difference (i.e., the flat-topped frequency excursion, Δf) is 5 GHz. Looking next at FIG. 4, standard Non-Return-To-Zero (NRZ) transmission is compared with the Frequency Reshaped Binary Transmission (FRBT) method of the present invention. The optimum parameters are a function of propagation distance, bit rate, and duty cycle of the pulse.

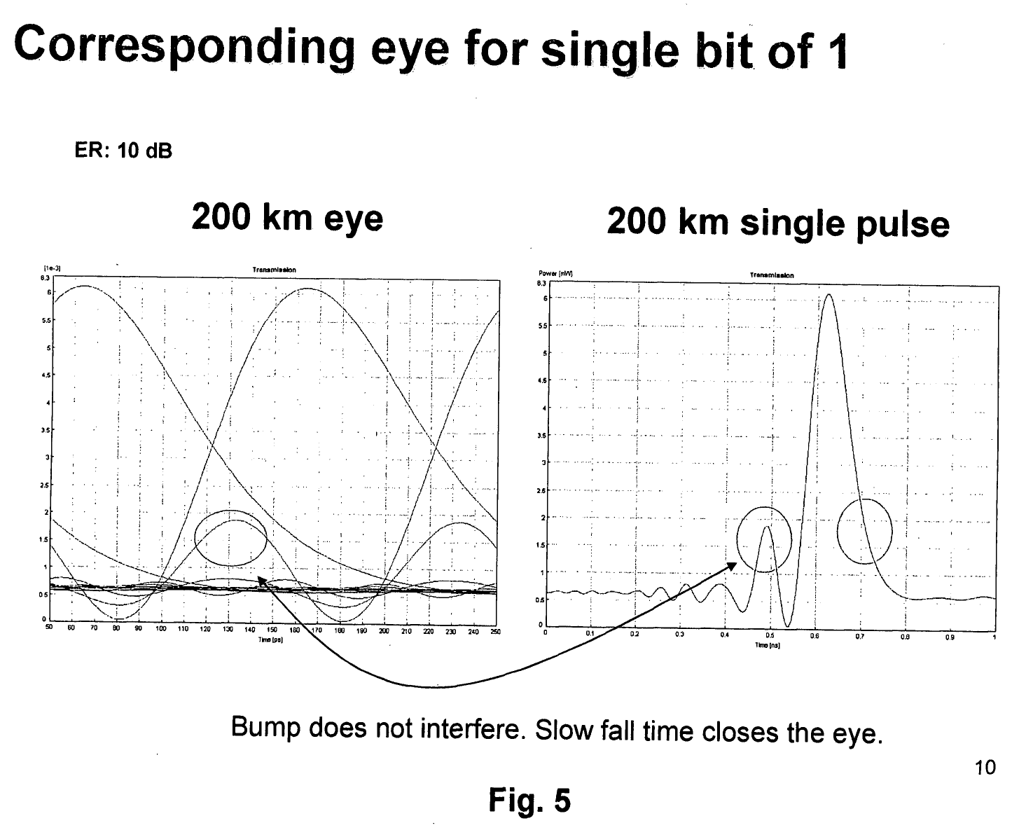

Looking next at FIG. 5, it can be seen that the pulse shape and frequency profile shown in FIG. 3 results in an open eye diagram even for the isolated 1 bit after propagation through 200 km of standard single mode fiber having 17 ps/nm/km of dispersion. Using 5 GHz of frequency difference (i.e., flat-topped frequency excursion, Δf) and 10 Gb/s transmission speed, beneficial advantage is taken of the πphase shift which occurs between 1's separated by an odd number of 0's. For a single isolated bit, there is an additional pulse narrowing that keeps the pulse from broadening after fiber dispersion. The pulse narrowing is the result of the destructive interference of the blue-shifted middle part of the pulse with the red-shifted energy in the wings on the rising edge, which are partially overlapped after fiber dispersion. This novel effect may be referred to, for convenience, as intra-pulse interference. For an optimum value of frequency difference, there will be a destructive interference or dip on the rising edge of the pulse, which in turn prevents its energy from spilling into the adjacent zero bit. The energy in the adjacent zero bit also helps the destructive interference as the pulse spreads more. This is why a finite extinction ratio is beneficial. It should also be appreciated that there is no interference on the falling edge because the wing of the pulse on the falling edge has the same optical frequency as the zeros bit to the right; the whole pulse and the zero energy move at the same speed and do not overlap. There is, therefore, no interference on the falling edge. The pulse spreads only in one direction and is prevented from distorting near its center due to this interference with the energy in the wings. If the sign of dispersion were reversed, the rising and falling edges would reverse roles, the pulse shape after propagation would flip from left to right, but the distortion would be minimal as in the previous case. Therefore, utilizing a Frequency Reshaped Binary Transmission (FRBT) technique in accordance with the present invention can produce a pulse shape that is tolerant to dispersion of either sign.

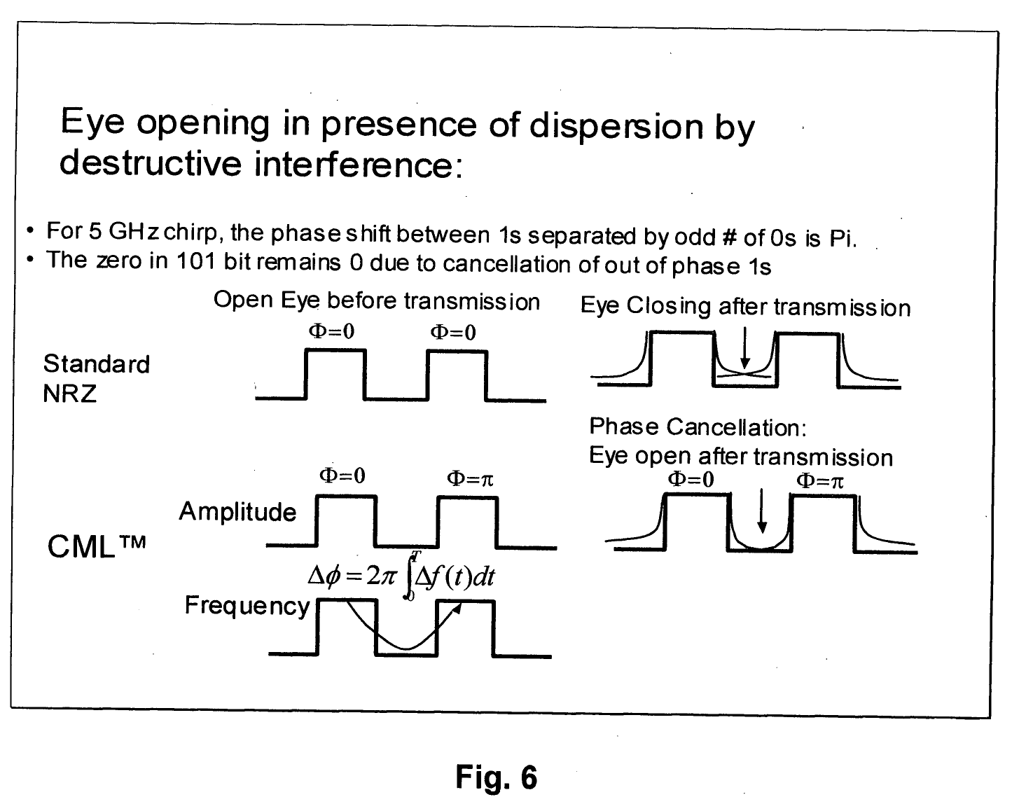

FIG. 6 shows how the Frequency Reshaped Binary Transmission (FRBT) technique of the present invention (referred to as CML™ in FIG. 6) can produce a pulse shape that is tolerant to dispersion of either sign.

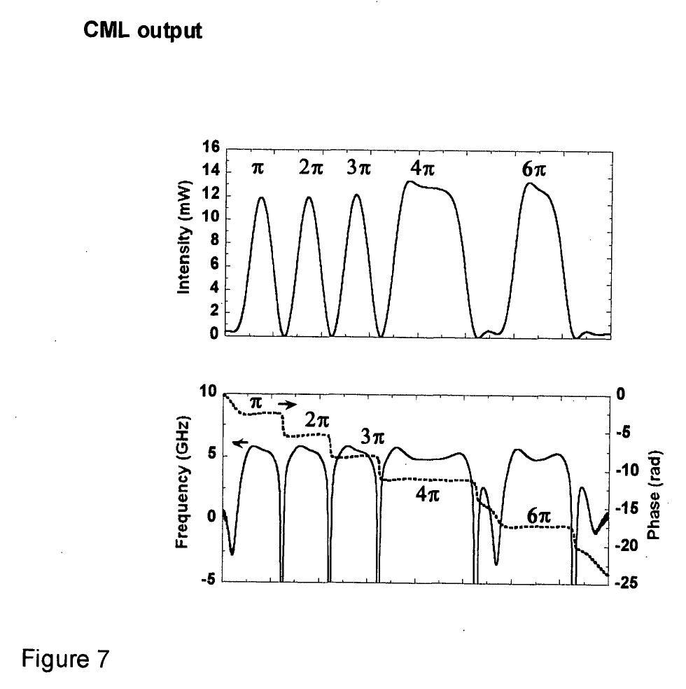

In the foregoing description the phase transition between 1 bits separated by one or more 0 bits has generally been characterized as being continuous. This is normally the case. However, in certain selected situations, e.g. where the 0 bit amplitude between 1 bits has substantially zero energy, the phase transition can appear to be discontinuous. This example is shown in FIG. 7. However, in the normal condition, the 0 bit typically does not have substantially zero energy and hence the phase transition generally appears to be continuous.

Furthermore, it should be appreciated that where a series of 0 bits occur in the bit sequence the phase transition may have a continuous and or discontinuous nature, as shown in FIG. 7. But in any case, at the conclusion of the zero string of bits the net phase shift between 1 bits will still be given by the product of the frequency difference between 1 bits and 0 bits and the time duration of the 0 bit.

The foregoing disclosure demonstrates the utility of the novel modulation scheme with an optical carrier wave. However, the same scheme can also be applied to a carrier wave in the Radio Frequency (RF) or other electromagnetic frequencies.

More particularly, in typical optical communication applications, the optical carrier is in the range of ˜194 THz, corresponding to a wavelength of ˜1550 nm. The digital data used to modulate the optical carrier typically has a bandwidth of between about 500 MHz to about 10 Gb/s (note that 10 Gb/s is the value used in the foregoing illustration).

In digital communications where electrical signals are propagated through copper wire or other Radio Frequency (RF) waveguides, a carrier wave typically has a frequency of several MHz to the GHz range. Video, for example, is typically in the range of ˜40 MHz to ˜800 MHz, while the information bandwidth is typically in the ˜6 MHz range. Since the equations governing propagation of an electromagnetic wave in a medium with dispersion are similar to those for an optical signal passing through a dispersive fiber, the modulation techniques described above can also be applied to electrical signal transmissions and thereby increase the propagation distance beyond the dispersion limit.

The schemes of the present invention can create tolerance to the real part of dispersion. In the case of an electrical signal, where copper wire or Radio Frequency (RF) metal waveguides are used, dispersion has a corresponding imaginary part, which appears in the form of a frequency dependent loss. The frequency dependent loss may be corrected for by pre-distortion of the signal or by amplification. However, in cases where propagation of digital Radio Frequency (RF) signals is limited by the real part of the dispersion, utilizing a Frequency Reshaped Binary Transmission (FRBT) technique in accordance with the present invention can increase the propagation distance. It can also be shown that a FRBT signal has nearly ½ the bandwidth of a standard NRZ signal, as described in U.S. Provisional Patent Application Ser. No. 60/581,076, filed Jun. 18, 2004 by Daniel Mahgerefteh et al. for PHASE CORRELATED AMPLITUDE MODULATION (Attorney's Docket No. TAYE-42 PROV) and/or U.S. Provisional Patent Application Ser. No. 60/615,834, filed Oct. 4, 2004 by Daniel Mahgerefteh et al. for PHASE CORRELATED QUADRATURE AMPLITUDE MODULATION (Attorney's Docket No. TAYE-45 PROV), which two patent applications are hereby incorporated herein by reference. This narrowing of bandwidth feature is also useful in the RF domain, where frequency dependent loss can narrow the available bandwidth.

It is to be understood that the present invention is by no means limited to the particular constructions herein disclosed and/or shown in the drawings, but also comprises any modifications or equivalents within the scope of the invention.

What is claimed is:

1. A method for transmitting binary data contained in respective successive time cells, the data being in the form of an optical signal obtained by amplitude modulation and frequency modulation of an optical carrier wave, with a 0 bit data value having a 0 bit mean amplitude having a 0 bit amplitude time duration and a 0 bit frequency having a 0 bit frequency duration, and a 1 bit data value having a 1 bit mean amplitude having a 1 bit amplitude time duration and a 1 bit frequency having a 1 bit frequency duration;
the improvement wherein:
independently adjusting the 0 bit mean amplitude relative to the 1 bit mean amplitude;
independently adjusting the 0 bit frequency relative to the 1 bit frequency; and
independently adjusting time duration of the frequency profile of the 1 bit relative to the time duration of the amplitude profile of the 1 bit,
whereby to extend the error-free propagation of the optical signal though a dispersive optical fiber beyond the dispersion limit.

2. A method according to claim 1, wherein additionally, the rise time and fall time of the 1 bit amplitude profile are independently adjusted relative to the rise time and fall time of the 1 bit frequency profile, whereby to extend the error-free propagation of the optical signal though a dispersive optical fiber beyond the dispersion limit.

3. A method according to claim 2, wherein said rise time of the said 1 bit frequency profile is faster than the rise time of the 1 bit amplitude profile, and wherein the fall time of said 1 bit frequency profile is faster than the fall time of the said 1 bit amplitude profile.

4. A method according to claim 1, wherein said 1 bit frequency time duration is shorter than said 1 bit amplitude time duration.

5. A method according to claim 1, wherein said 1 bit frequency time duration is longer than said 1 bit amplitude time duration.

6. A method according to claim 1, wherein said 1 bit frequency profile is substantially square shaped with a flat-topped and encompasses the 1 bit amplitude profile.

7. A method according to claim 2, wherein the product of the time duration of the frequency profile of the 0 bit and the difference between the 1 bit frequency and the 0 bit frequency is substantially equal to an odd integer multiple of ½.

8. A method according to claim 2, wherein the product of the time duration of the frequency profile of the 0 bit and the difference between the 1 bit frequency and the 0 bit frequency is an odd integer multiple of a fraction of between about ¼ to about ¾.

9. A method according to claim 1, wherein the ratio of the 1 bit mean amplitude to the 0 bit mean amplitude is approximately 10 to 30.

10. A method according to claim 1, wherein the binary data format is non-return-to-zero.

11. A method according to claim 1, wherein the binary data format is return-to-zero.

12. A method for transmitting binary data contained in respective successive time cells, the data being in the form of an electrical signal obtained by amplitude modulation and frequency modulation of an electrical carrier wave, with a 0 bit data value having a 0 bit mean amplitude having a 0 bit amplitude time duration and a 0 bit frequency having a 0 bit frequency duration, and a 1 bit data value having a 1 bit mean amplitude having a 1 bit amplitude time duration and a 1 bit frequency having a 1 bit frequency duration;
the improvement wherein:
independently adjusting the 0 bit mean amplitude relative to 1 bit mean amplitude;
independently adjusting the 0 bit frequency relative to the 1 bit frequency; and
independently adjusting the frequency time duration of the 1 bit relative to the amplitude time duration of the 1 bit,
whereby to extend the error-free propagation of the electrical signal though a dispersive waveguide beyond the dispersion limit.

13. A method for transmitting Non-Return-To-Zero (NRZ) binary data contained in respective successive time cells, the data being in the form of an optical signal obtained by amplitude modulation and frequency modulation of an optical carrier wave, with a 0 bit data value having a 0 bit mean amplitude having a 0 bit amplitude time duration and a 0 bit frequency having a 0 bit frequency duration, and a 1 bit data value having a 1 bit mean amplitude having a 1 bit amplitude time duration and a 1 bit frequency having a 1 bit frequency duration;
the improvement wherein:
the phase across each 1 bit data value is substantially constant, and the phase of the carrier changes across each and every 0 bit by an amount equal to the product of the frequency difference between the 1 bit and the 0 bit and the duration of the 0 bit;
whereby to extend the error-free propagation of the optical signal though a dispersive optical fiber beyond the dispersion limit.

14. A method according to claim 13 wherein the phase change across a 0 bit is between an odd integer multiple of Π/2 and 3Π/2.

15. A method according to claim 13 wherein the phase change across a 0 bit is an odd integer multiple of Π.

16. A method according to claim 13, wherein the 1 bit frequency has a shape which is substantially flat-topped.

17. A method for transmitting binary data contained in respective successive time cells, the data being in the form of an optical signal obtained by amplitude modulation and frequency modulation of an optical carrier wave, with a 0 bit data value having a 0 bit mean amplitude having a 0 bit amplitude time duration and a 0 bit frequency having a 0 bit frequency duration, and a 1 bit data value having a 1 bit mean amplitude having a 1 bit amplitude time duration and a 1 bit frequency having a 1 bit frequency duration;
the improvement wherein:
the amplitude profile of the 1 bit is substantially bell-shaped, and the frequency profile of the 1 bit is substantially square-shaped, with steeper rise and fall time and a wider flat top region;
whereby to extend the error-free propagation of the optical signal though a dispersive optical fiber beyond the dispersion limit.
